(19) United States
(12) Patent Application Publication
(10) Pub. No.: US 2015/0056880 A1
(43) Pub. Date: Feb. 26, 2015

(54) ECO-FRIENDLY AND HIGH-STRENGTH RESIN COMPOSITE MATERIAL

(71) Applicant: LG Hausys, Ltd., Seoul (KR)

(72) Inventors: Eung Kee Lee, Anyang-si (KR); Min Hee Lee, Gunpo-si (KR); Chang Hak Shin, Seoul (KR); Ku Il Park, Yongin-si (KR); Jung Seop Lim, Gunpo-si (KR)

(21) Appl. No.: 14/388,426

(22) PCT Filed: Dec. 28, 2012
(86) PCT No.: PCT/KR2012/011765

§ 371 Date: Sep. 26, 2014

(30) Foreign Application Priority Data
Apr. 9, 2012 (KR) 10-2012-0036605

(51) Int. Cl. B32B 27/36; B32B 5/02; C08L 67/04

(52) U.S. Cl. CPC B32B 27/36; C08L 67/04; B32B 5/024; B32B 5/022; C08L 2201/06; C08L 2205/02; B32B 2260/021; B32B 2262/0253; B32B 2262/0269; B32B 2262/101; B32B 2307/54
USPC 442/164; 428/480; 428/430; 428/475.2; 428/483

(57) ABSTRACT

Disclosed is an eco-friendly and high-strength resin composite material which has high-strength and light weight properties. The eco-friendly and high-strength resin composite material according to the present invention includes: a first base material; a reinforcing material layer formed on the first base material and having a fibrous reinforcement; and a second base material formed on the reinforcing layer. The first base material and/or the second base material are made with a biodegradable resin, such as the PLA and PHA resins.

### TECHNICAL FIELD

The present invention relates to a high-strength resin composite, and more particularly, to an eco-friendly resin composite having high strength and a light weight using a blend resin, in which a polylactic acid (PLA) resin and a polyhydroxyalkanoate (PHA) resin are mixed, as a base layer.

### BACKGROUND ART

A high-strength resin composite refers to a material in which a resin such as a thermoplastic resin is reinforced with fibers. Such a high-strength resin composite is lightweight and has high strength.

The high-strength resin composite typically refers to fiber-reinforced plastics (FRP), and the fiber-reinforced plastics have a structure in which fibers such as carbon fibers are impregnated into a resin. However, such fiber-reinforced plastics exhibit significant deterioration in tensile strength with increasing amount of carbon fibers and have poor moldability.

Moreover, the high-strength resin composite typically employs a commercial thermoplastic resin such as polypropylene (PP), nylon, and polyethylene terephthalate (PET) resins. However, the commercial thermoplastic resins cause environmental contamination, since the resins are not decomposed when discarded.

To solve such problems, application of a biodegradable resin to the high-strength resin composite has been attempted in recent years. However, there is a problem in that the biodegradable resin generally exhibits poorer properties in terms of strength and the like than commercial thermoplastic resins.

In the related art, Korean Patent Publication No. 10-2009-0099215 (published on Sep. 22, 2009) discloses a process of preparing a high-strength thermoplastic composite reinforced with continuous fibers.

### DISCLOSURE

### Technical Problem

It is an aspect of the present invention to provide a high-strength resin composite which exhibits strength equal or superior to that of existing resin composites based on commercial thermoplastic resins, and has eco-friendliness by securing biodegradability.

### Technical Solution

In accordance with one aspect of the present invention, an eco-friendly high-strength resin composite includes: a base layer; and a reinforcing material layer formed on one or both surfaces of the base layer and including a fibrous reinforcing agent, wherein the base layer is formed with a biodegradable resin including a polylactic acid (PLA) resin and a polyhydroxyalkanoate (PHA) resin.

The biodegradable resin may be prepared by blending 10 parts by weight to 50 parts by weight of the PHA resin based on 100 parts by weight of the PLA resin.

In addition, the biodegradable resin may further include an ionomer.

The PHA resin may include a repeating unit represented by Formula 1:

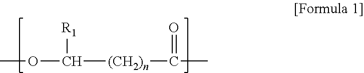

(wherein R₁ is a hydrogen atom or a substituted or unsubstituted C₁ to C₁₅ alkyl group; and n is 1 or 2).

In accordance with another aspect of the present invention, an eco-friendly high-strength resin composite includes: a first base layer; a reinforcing material layer formed on the first base layer and including a fibrous reinforcing agent; and a second base layer formed on the reinforcing material layer, wherein at least one of the first base layer and the second base layer is formed with a biodegradable resin including a PLA resin and a PHA resin.

Here, both the first base layer and the second base layer may include the biodegradable resin.

### Advantageous Effects

According to the present invention, the eco-friendly high-strength resin composite employs a blended resin, in which a PLA resin and a PHA resin are mixed, as a base layer, and includes a separate reinforcing material layer formed on the base layer using a fibrous reinforcing agent.

As a result, the eco-friendly high-strength resin composite according to the present invention can secure properties equal or superior to those of existing high-strength resin composites based on commercial thermoplastic resins, and has eco-friendliness by securing biodegradability of the base layer after disposal thereof.

### DESCRIPTION OF DRAWINGS

FIG. 1 is a schematic diagram of an eco-friendly high-strength resin composite, in which a reinforcing material layer is formed on one surface of a base layer, according to one embodiment of the present invention.

FIG. 2 is a schematic diagram of an eco-friendly high-strength resin composite, in which reinforcing material layers are formed on both surfaces of a base layer, according to another embodiment of the present invention.

FIG. 3 is a schematic diagram of an eco-friendly high-strength resin composite, in which a reinforcing material layer is formed between the first base layer and the second base layer, according to a further embodiment of the present invention.

### BEST MODE

The above and other aspects, features and advantages of the present invention will become apparent from the detailed description of the following embodiments in conjunction with the accompanying drawings.

However, it should be understood that the present invention is not limited to the following embodiments and may be embodied in different ways, and that the embodiments are provided for complete disclosure and thorough understanding of the invention by those skilled in the art. The scope of the invention should be defined only by the accompanying claims and equivalents thereof.

Hereinafter, exemplary embodiments of the present invention will be described in detail with reference to the accompanying drawings.

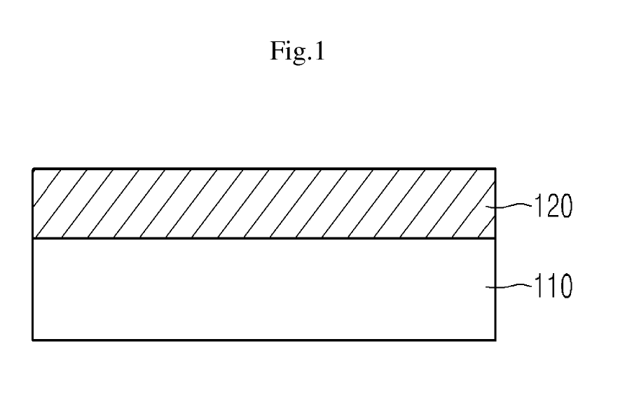

FIG. 1 is a schematic diagram of an eco-friendly high-strength resin composite, in which a reinforcing material layer is formed on one surface of a base layer, according to one embodiment of the present invention.

Referring to FIG. 1, an eco-friendly high-strength resin composite according to one embodiment of the present invention includes a base layer 110 and a reinforcing material layer 120.

According to the present invention, the base layer 110 serves to effectively transfer load to parts and the like, which adjoin the resin composite or are connected thereto, and serves to support the fibrous reinforcing agent in the reinforcing material layer 120.

The base layer 110 may take the form of a film, a woven fabric, a non-woven fabric, a pelt, and the like. In addition, the base layer 110 may have a single layer structure, or a stacked structure of two layers or more .

Here, the base layer 110 includes a biodegradable resin. Here, the biodegradable resin may be a blended resin in which a polylactic acid (PLA) resin and a polyhydroxyalkanoate (PHA) resin are mixed.

Inventors of the present invention found that the blended resin in which the PLA resin and the PHA resin are mixed can exhibit mechanical properties equal to those of commercial thermoplastic resins, such as polypropylene resins, polyethylene terephthalate resins, and the like.

Therefore, since the resin composite according to the present invention employs the blended resin, in which the PLA resin and the PHA resin are mixed, as the base layer, there are merits in that the resin composite exhibits excellent properties in terms of strength and the like, and can biodegrade after disposal thereof.

The PHA resin may include a repeating unit represented by Formula 1:

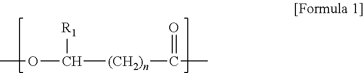

(wherein R₁ is a hydrogen atom, or a substituted or unsubstituted C₁ to C₁₅ alkyl group; and n is 1 or 2).

More specifically, the repeating unit represented by Formula 1 may include 3-hydroxybutyrate when n is 1 and R₁ is a methyl group, 3-hydroxyvalerate when n is 1 and R₁ is an ethyl group, 3-hydroxyhexanoate when n is 1 and R₁ is a propyl group, 3-hydroxyoctanoate when n is 1 and R₁ is a pentyl group, 3-hydroxyoctadecanoate when n is 1 and R₁ is a C₁₅ alkyl group, and the like.

In the resin composite according to the present invention, the PLA resin serves to secure strength, and the PHA resin serves to improve brittleness of the PLA resin. Thus, it can be understood that the resin composite exhibits higher strength as the content of the PLA resin increases, and that the resin composite exhibits higher toughness as the content of the PHA resin increases.

According to the present invention, the resin composite may have any mixing ratio of the PLA resin and the PHA. However, as a result of experiments, the resin composite in which the PHA resin is mixed in an amount of 10 parts by weight to 50 parts by weight based on 100 parts by weight of the PLA resin exhibited better properties than other resin composites.

On the other hand, if the PHA resin is present in an amount of less than 10 parts by weight based on 100 parts by weight of the PLA resin, it is difficult to secure improvement in brittleness of the PLA resin. In addition, if the PHA resin is present in an amount of greater than 50 parts by weight based on 100 parts by weight of the PLA resin, the resin composite can exhibit more or less deteriorated strength due to cohesion of the PHA resin.

Thus, most preferably, the PHA resin is mixed in an amount of 10 parts by weight to 50 parts by weight based on 100 parts by weight of the PLA resin.

In addition, the biodegradable resin may further include an ionomer.

The ionomer can act as a reactive compatibilizer.

The ionomer may be any ionomer so long as the ionomer includes a nonpolar polymeric chain containing a small amount of ions. Examples of the ionomer may include copolymers of α-olefins and α,β-unsaturated carboxylic acids, polymers in which sulfonic acid is introduced into polystyrene, copolymers of α-olefins, α,β-unsaturated carboxylic acids, monomers copolymerizable therewith, and mixtures thereof neutralized with a monovalent to tertvalent metal ion.

The ionomer may be present in an amount of 20 parts by weight or less, based on 100 parts by weight in total of the PLA resin and the PHA resin. If the amount of the ionomer is greater than 20 parts by weight, the resin composite can suffer from deterioration in heat resistance or strength due to the unreacted ionomer.

The reinforcing material layer 120 is formed on one surface of the base layer. In addition, the reinforcing material layer 120 includes the fibrous reinforcing agent.

The reinforcing material layer 120 may be formed by bonding or press-bonding a fibrous reinforcing agent-containing sheet to the base layer 110. Alternatively, instead of using the sheet, the fibrous reinforcing agent itself may also be press-bonded to the base layer by pressing to form the reinforcing material layer 120.

In the resin composite according to the present invention, the fibrous reinforcing agent contained in the reinforcing material layer serves to support load due to external force. The fibrous reinforcing agent may include at least one type of industrial fibers such as carbon fibers, glass fibers, aramid fibers, ultra high molecular weight polyethylene (UHMWPE), and the like.

The fibrous reinforcing agent contained in the reinforcing material layer 120 may be present in an amount of 10 parts by weight to 100 parts by weight based on 100 parts by weight of the base layer 110. However, the amount of the fibrous reinforcing agent is not limited thereto, and may vary according to application.

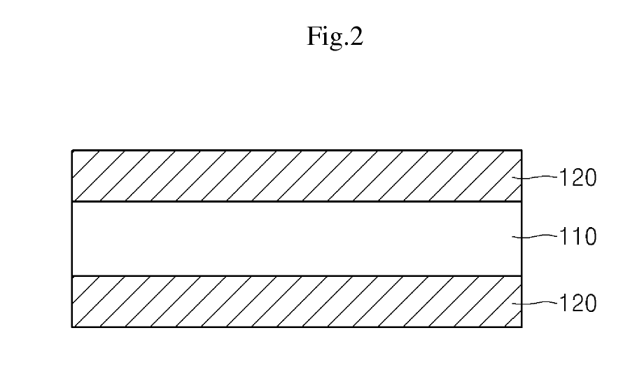

In FIG. 1, the reinforcing material layer 120 is formed on one surface of the base layer 110. However, as shown in FIG. 2, the reinforcing material layers 120 may be formed on both surfaces of the base layer 110.

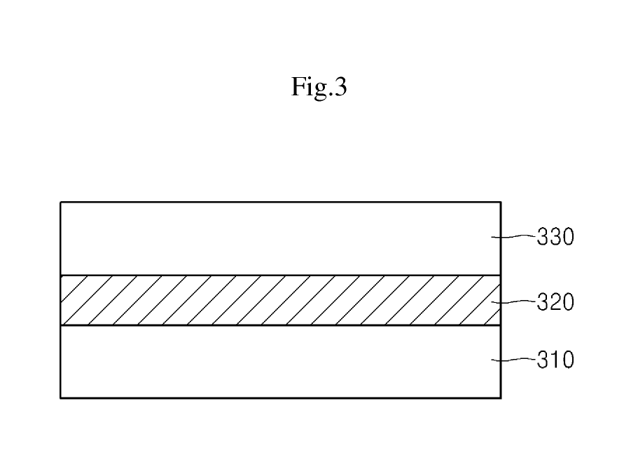

FIG. 3 is a schematic diagram of an eco-friendly high-strength resin composite, in which a reinforcing material layer is formed between the first base layer and the second base layer, according to a further embodiment of the present invention.

Referring to FIG. 3, an eco-friendly high-strength resin composite includes a first base layer 310, a reinforcing material layer 320, and a second base layer 330.

Referring to FIG. 3, the resin composite has a structure in which the reinforcing material layer 320 is interposed between the first base layer 310 and the second base layer 330.

The first base layer 310 and the second base layer 330 may be in the form of one of a film, a woven fabric, a non-woven fabric and a pelt, or have a stacked structure of two or more thereof.

Here, the first base layer 310 or the second base layer 330, preferably both of the first base layer 310 and the second base layer 330, include a biodegradable resin.

As described above, according to the present invention, the biodegradable resin is a blended resin in which a PLA resin and a PHA resin are mixed. In addition, the biodegradable resin may include an ionomer.

The reinforcing material layer 320 is formed on the first base layer and includes a fibrous reinforcing agent.

The fibrous reinforcing agent may include at least one of industrial fibers such as carbon fibers, glass fibers, aramid fibers, UHMWPE, and the like.

In FIG. 3, since the reinforcing material layer 320 is interposed between the first base layer 310 and the second base layer 330, the reinforcing material layer 320 can be suppressed from departing from the matrices as much as possible.

As described above, the eco-friendly high-strength resin composite according to the present invention can be lightweight and high strength, can prevent environmental contamination by employing the blended resin, in which the PLA resin and the PHA resin are mixed, as the base layer, and thus can be naturally degraded due to biodegradability when discarded.

In addition, the eco-friendly high-strength resin composite according to the present invention can be prepared simply by press-bonding, bonding or the like. Thus, the resin composite according to the present invention can be prepared by a simpler process than fiber-reinforced plastics (FRPs) in which a fibrous reinforcing agent is impregnated into a base layer.

Further, an excess of the fibrous reinforcing agent in the fiber-reinforced plastics causes problems of significant deterioration in tensile strength and poor moldability. However, the resin composite according to the present invention includes the fibrous reinforcing agent-containing reinforcing material layer formed in a separate layer from the base layer, thereby sufficiently increasing the amount or density of the fibrous reinforcing agent in the reinforcing material layer.

### EXAMPLE

Next, the present invention will be explained in more detail with reference to some examples. However, it should be understood that these examples are provided for illustration only and are not to be construed in any way as limiting the present invention.

A description of details apparent to those skilled in the art will be omitted for clarity.

1. Preparation of Resin Composite Specimen

### Example 1

Carbon fibers (25% weight of film) were arranged on a film having a size of 10 cm×10 cm×0.5 mm, followed by pressing, thereby preparing a resin composite specimen. Here, the film was prepared by blending 25 parts by weight of a PHA resin with 100 parts by weight of a PLA resin.

### Example 2

Carbon fibers (25% weight of film) were arranged on a film having a size of 10 cm×10 cm×0.5 mm, followed by placing the same kind of film thereon and pressing, thereby preparing a resin composite specimen. Here, the two films were prepared by blending 25 parts by weight of a PHA resin with 100 parts by weight of a PLA resin.

### Example 3

A resin composite specimen was prepared in the same manner as in Example 2 except that each of the two films further included 10 parts by weight of an ionomer Surlyn® 1706 (Dupont Co., Ltd.) based on 100 parts by weight of the PLA resin.

### Example 4

A resin composite specimen was prepared in the same manner as in Example 2 except that the carbon fibers were used in an amount of 100 wt % based on the weight of the film.

### Comparative Example 1

A resin composite specimen was prepared in the same manner as in Example 2 except that the two films were PET films (LG Chem, Ltd.).

### Comparative Example 2

30 parts by weight of carbon fibers was added to a molten resin in which 100 parts by weight of a PLA resin were blended with 25 parts by weight of a PHA resin, followed by stirring and extrusion, thereby preparing a resin composite specimen, in which the carbon fibers were impregnated into the PLA resin, to the same size as in Example 1.

### Comparative Example 3

A resin composite specimen was prepared in the same manner as in Comparative Example 2 except that 100 parts by weight of carbon fibers was used based on 100 parts by weight of the PLA resin.

2. Property Evaluation

The specimens of Examples 1 to 4 and Comparative Examples 1 to 3 were evaluated as to tensile strength and flexural strength.

Tensile strength (unit: kgf/cm²) was measured in accordance with ASTM D638.

Flexural strength (unit: kgf/cm²) was measured in accordance with ASTM D790.

3. Results of Property Evaluation

Results of property evaluation for the specimens of Examples 1 to 4 and Comparative Examples 1 to 3 are shown in Table 1.

TABLE 1

| | Example | | | | Comparative Example | | |
|---|---|---|---|---|---|---|---|
| | 1 | 2 | 3 | 4 | 1 | 2 | 3 |
| Tensile strength | 792 | 852 | 926 | 896 | 868 | 791 | 580 |
| (Kgf/cm²) | | | | | | | |
| Flexural strength | 976 | 998 | 1107 | 1249 | 1012 | 948 | 1029 |
| (Kgf/cm²) | | | | | | | |

Referring to Table 1, the resin composite specimens of Examples 1 to 4 exhibited properties equal or superior to those of the PET resin-based resin composite specimen of Comparative Example 1. Here, a base layer of the resin composite of Comparative Example 2 is based on a non-biodegradable PET film, whereas the resin composites of Examples 1 to 4 are biodegradable while exhibiting properties equal or superior to those of the resin composite of Comparative Example 2, and can be sufficiently utilized as an eco-friendly material. In particular, the resin composite specimens of Examples 2 to 4, which were prepared using a PLA resin film and had a structure as shown in FIG. 3, exhibited superior strength, and the resin composite specimen of Example 3 including the ionomer exhibited the best properties.

The specimen of Comparative Example 2 having a FRP form exhibited a slightly lower strength than the specimen of Example 1, and the specimen of Comparative Example 3 including a high amount of the carbon fibers exhibited extremely low tensile strength.

Although the present invention has been described with reference to some embodiments, it should be understood that the foregoing embodiments are provided for illustration only, and that various modifications, changes, alterations, and equivalent embodiments can be made by those skilled in the art without departing from the spirit and scope of the invention. Therefore, the scope of the invention should be defined only by the accompanying claims and equivalents thereof.

### DESCRIPTION OF REFERENCE NUMERALS

| | |
|---|---|
| 110: base layer | 120: reinforcing material layer |
| 310: first base layer | 320: reinforcing material layer |
| 330: second base layer | |

1. An eco-friendly high-strength resin composite comprising:
a base layer; and
a reinforcing material layer formed on one or both surfaces of the base layer and comprising a fibrous reinforcing agent,
wherein the base layer is formed with a biodegradable resin comprising a polylactic acid (PLA) resin and a polyhydroxyalkanoate (PHA) resin.

2. The resin composite according to claim 1, wherein the biodegradable resin is prepared by blending 10 parts by weight to 50 parts by weight of the PHA resin based on 100 parts by weight of the PLA resin.

3. The resin composite according to claim 1, wherein the biodegradable resin further comprises an ionomer.

4. The resin composite according to claim 1, wherein the PHA resin comprises a repeating unit represented by Formula 1: 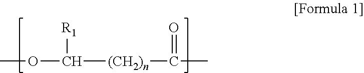
(wherein R₁ is a hydrogen atom or a substituted or unsubstituted C₁ to C₁₅ alkyl group; and n is 1 or 2).

5. The resin composite according to claim 1, wherein the base layer has a single layer structure of one selected from a film, a woven fabric, a non-woven fabric and a pelt, or has a stacked structure of at least two thereof.

6. The resin composite according to claim 1, wherein the fibrous reinforcing agent comprises at least one selected from carbon fibers, glass fibers, aramid fibers, and ultra high molecular weight polyethylene (UHMWPE).

7. An eco-friendly high-strength resin composite comprising:
a first base layer;
a reinforcing material layer formed on the first base layer and comprising a fibrous reinforcing agent; and
a second base layer formed on the reinforcing material layer,
wherein at least one of the first base layer and the second base layer is formed with a biodegradable resin comprising a PLA resin and a PHA resin.

8. The resin composite according to claim 7, wherein the biodegradable resin is prepared by blending 10 parts by weight to 50 parts by weight of the PHA resin based on 100 parts by weight of the PLA resin.

9. The resin composite according to claim 7, wherein the biodegradable resin further comprises an ionomer.

10. The resin composite according to claim 7, wherein the first base layer and the second base layer have a single layer structure of one selected from a film, a woven fabric, a non-woven fabric and a pelt, or has a stacked structure of at least two thereof.

11. The resin composite according to claim 7, wherein the fibrous reinforcing agent comprises at least one selected from carbon fibers, glass fibers, aramid fibers, and ultra high molecular weight polyethylene (UHMWPE).
